(19) United States
(12) Patent Application Publication
(10) Pub. No.: US 2026/0133443 A1
(43) Pub. Date: May 14, 2026

(54) OPTICAL MODULATOR

(71) Applicant: Mitsubishi Electric Corporation, Tokyo (JP)

(72) Inventors: Tadashi MURAO, Tokyo (JP); Tsuyoshi HORIKAWA, Tokyo (JP)

(73) Assignee: Mitsubishi Electric Corporation, Tokyo (JP)

(21) Appl. No.: 19/429,710

(22) Filed: Dec. 22, 2025

Related U.S. Application Data
(63) Continuation of application No. PCT/JP2023/027671, filed on Jul. 28, 2023.

(51) Int. Cl. G02F 1/025

(52) U.S. Cl. CPC G02F 1/025; G02F 2203/50

(57) ABSTRACT

An optical modulator includes: a light-entrance-side waveguide; a light-output-side waveguide; a grating provided on the light-entrance-side waveguide; a grating provided on the light-output-side waveguide; and an optical resonator provided between the grating and the grating, and having: an MMI to branch light having passed through the grating; parallel waveguides extending in parallel from the MMI; and an MMI to multiplex light having passed through the parallel waveguides, and output the multiplexed light to the grating, in which the optical resonator outputs, to the grating, the multiplexed light of the light having passed through the parallel waveguides without introducing a phase difference therebetween in an optical modulation ON state, and outputs, to the grating, the multiplexed light of the light having passed through the parallel waveguides with a phase difference introduced therebetween in an optical modulation OFF state.

### CROSS REFERENCE TO RELATED APPLICATION

This application is a Continuation of PCT International Application No. PCT/JP2023/027671, filed on July 28, 2023, which is hereby expressly incorporated by reference into the present application.

### TECHNICAL FIELD

The present disclosure relates to an optical modulator.

### BACKGROUND ART

In the communication form called co-packaged optics (hereinbelow, written as CPO), it is possible to reduce power consumption by minimizing the length of a high-frequency signal line provided on the input side of an optical modulator. Optical modulators in CPO are required to have an enhanced degree of integration that allows size-reduction, non-hermeticity that eliminates the necessity for airtight sealing, and operation that does not require temperature adjustment.

On the other hand, for example, Mach-Zehnder (hereinbelow, written as MZ) type silicon optical modulators can satisfy all the requirements mentioned above. It should be noted that, since MZ type silicon optical modulators have a phase shifter using the carrier plasma effect, there is a problem that the modulation efficiency is low, and correspondingly the dynamic extinction ratio, which is an optical modulation width, is low.

As a conventional technology for solving the problem mentioned above, for example, there is an optical modulator described in Non-Patent Literature 1. The optical modulator has a longer phase shifter area through which light waves propagate in order to increase the interaction length between light waves and a phase shifter.

### CITATION LIST

### NON-PATENT LITERATURE

Non-Patent Literature 1: T. Baehr-Jones et al., "Ultralow drive voltage silicon traveling-wave modulator," Opt. Express, vol. 20, 12014-12020, May 2012.

### SUMMARY OF INVENTION

### TECHNICAL PROBLEM

However, in the conventional optical modulator described in Non-Patent Literature 1, optical losses caused by the carrier plasma effect increase as the length of the phase shifter increases. Because of this, there has been a problem that the length of a traveling-wave electrode for applying an electric signal to the optical modulator also needs to be increased depending on the length of the phase shifter, and high-frequency losses in the traveling-wave electrode cause bandwidth degradation in the high frequency characteristics.

The present disclosure aims to solve the problems described above, and an object thereof is to obtain an optical modulator that can enhance the dynamic extinction ratio without causing optical losses or bandwidth degradation in the high frequency characteristics.

### SOLUTION TO PROBLEM

An optical modulator according to the present disclosure includes: a light- entrance-side waveguide where light enters; a light-output-side waveguide where light is output; a first semi-transparent mirror provided on the light-entrance-side waveguide; a second semi-transparent mirror provided on the light-output-side waveguide; and an optical resonator provided between the first semi-transparent mirror and the second semi-transparent mirror, and having: a branch to branch light having passed through the first semi-transparent mirror; parallel waveguides that extend in parallel from the branch, and allow passage of light branched by the branch; and a multiplexer to multiplex light having passed through the parallel waveguides, and output the multiplexed light to the second semi-transparent mirror, in which the optical resonator outputs, to the second semi-transparent mirror, the multiplexed light of the light having passed through the parallel waveguides without introducing a phase difference therebetween in an optical modulation ON state, and outputs, to the second semi-transparent mirror, the multiplexed light of the light having passed through the parallel waveguides with a phase difference introduced therebetween in an optical modulation OFF state.

### ADVANTAGEOUS EFFECTS OF INVENTION

According to the present disclosure, an optical resonator is provided between a first semi-transparent mirror and a second semi-transparent mirror, and has: a branch to branch light having passed through the first semi-transparent mirror; parallel waveguides that extend in parallel from the branch; and a multiplexer to multiplex light having passed through the parallel waveguides, and output the multiplexed light to the second semi-transparent mirror. The optical resonator outputs, to the second semi-transparent mirror, the multiplexed light of the light having passed through the parallel waveguides without introducing a phase difference therebetween in an optical modulation ON state, and outputs, to the second semi-transparent mirror, the multiplexed light of the light having passed through the parallel waveguides with a phase difference introduced therebetween in an optical modulation OFF state.

The refractive indices of light of the parallel waveguides are determined so that the light having passed through the parallel waveguides interferes with each other with a phase difference of almost zero in the optical modulation ON state. If the operating wavelength is a wavelength that satisfies a resonance condition that is determined by the refractive indices and the distance between the first semi-transparent mirror and the second semi-transparent mirror, the light having passed through the parallel waveguides undergoes resonant tunneling in the optical resonator, and the light passes from the light-entrance-side waveguide to the light-output-side waveguide without any loss.

On the other hand, since the refractive indices of light of the parallel waveguides are determined so that the light having passed through the parallel waveguides has a phase difference in the optical modulation OFF state, the power of light that passes from the light-entrance-side waveguide to the light-output-side waveguide lowers depending on the phase difference. Moreover, with the refractive indices, the resonance condition is no longer satisfied between the first semi-transparent mirror and the second semi-transparent mirror. Accordingly, light having entered from the light-entrance-side waveguide undergoes anti-resonant reflection, thereby further lowering the power of light that passes to the light-output-side waveguide.

Thereby, the power ratio and power difference of light that passes from the light-entrance-side waveguide to the light-output-side waveguide can be obtained between the optical modulation ON state and the optical modulation OFF state. Accordingly, the optical modulator according to the present disclosure can enhance the dynamic extinction ratio without causing optical losses or bandwidth degradation in the high frequency characteristics.

### BRIEF DESCRIPTION OF DRAWINGS

FIG. 1 is a planar schematic diagram schematically illustrating the configuration of a conventional optical modulator.

FIG. 2 is a planar schematic diagram schematically illustrating the configuration of an optical modulator according to a first embodiment.

FIG. 3 is an enlarged cross-sectional view illustrating a cross section of the optical modulator according to the first embodiment taken along line A-A in FIG. 2.

FIG. 4 is a graph illustrating the wavelength dependency of the dynamic extinction ratios of the optical modulators.

FIG. 5 is a planar schematic diagram schematically illustrating the configuration according to a modification example of the optical modulator according to the first embodiment.

### DESCRIPTION OF EMBODIMENTS

### First Embodiment

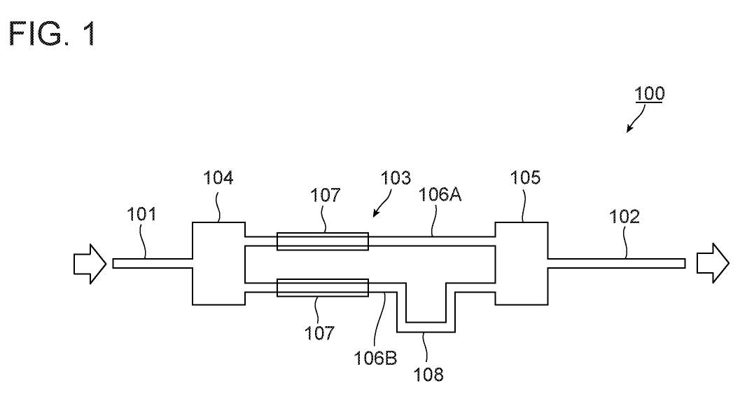

First, a conventional optical modulator and its problems are explained using FIG. 1.

Optical communication includes intensity modulation optical communication and digital coherent optical communication. For example, in optical communication at a data center, an intensity modulation scheme is used for optical communication for relatively short distances such as within the data center, and a digital coherent scheme is used for optical communication for long distances such as between data centers. MZ type optical modulators are used for intensity modulation schemes. In addition, digital coherent schemes can also be implemented by using MZ type optical modulators in parallel.

FIG. 1 is a planar schematic diagram schematically illustrating the configuration of a conventional optical modulator 100. In FIG. 1, the optical modulator 100 is an MZ type optical modulator, and includes a light-entrance-side waveguide 101, a light-output-side waveguide 102, and an MZ interferometer 103. In addition, the MZ interferometer 103 has a multimode interference waveguide (hereinbelow, written as MMI) 104, an MMI 105, parallel waveguides 106A and 106B, phase shifters 107, and a delay line 108.

The optical modulator 100 phase-shifts light passing through the parallel waveguide 106A and light passing through the parallel waveguide 106B by changing the refractive indices of light of the parallel waveguides 106A and 106B using the phase shifters 107 and the delay line 108. The optical modulator 100 generates symbols "1" or "0" by introducing a phase difference to the light passing through the parallel waveguide 106A and the light passing through the parallel waveguide 106B, and allowing the MMI 105 to cause interference between the light with different phases. The state where the optical modulator 100 generates the symbol "1" is the optical modulation ON state, and the state where the optical modulator 100 generate the symbol "0" is the optical modulation OFF state.

As represented by arrows in FIG. 1, light input to the light-entrance-side waveguide 101 is branched by the MMI 104, passes through the parallel waveguides 106A and 106B, the phase shifters 107, and the delay line 108, is multiplexed by the MMI 105, and is output to the light-output-side waveguide 102. Note that instead of the MMIs 104 and 105, Y-branch waveguides are used in some cases. In addition, whereas the phase shifters 107 are provided on both the parallel waveguide 106A and the parallel waveguide 106B in the structure illustrated in FIG. 1, a phase shifter 107 is provided on either of the parallel waveguide 106A and the parallel waveguide 106B in some cases.

In the optical modulator 100 used for intensity modulation optical communication, for example, a phase difference of π/2 is introduced between the parallel waveguide 106A and the parallel waveguide 106B. The delay line 108 is provided on the parallel waveguide 106B in order to introduce the phase difference.

Note that, although not illustrated in FIG. 1, instead of the delay line 108, a heater is installed in some cases. For example, in a case where a heater is installed on the parallel waveguide 106B, the heater heats the core of the parallel waveguide 106B. Thereby, the refractive index of light of the parallel waveguide 106B changes, and the light passing through the parallel waveguide 106B is phase-shifted. The change in the refractive index of light of a waveguide due to the warming of its core is called the thermo-optic effect. In the thermo-optic effect, there is almost no wavelength dependency of the phase shift amount.

In addition, light having been propagated through the parallel waveguide 106B from the light entrance-side to the light output side experiences a phase delay by being propagated through the delay line 108. Unlike in the case of a heater, in the phase shift using the delay line 108, the phase shift amount of light passing through the parallel waveguide 106B is significantly dependent on the wavelength of the light. In other words, by changing the incident wavelength of light passing through the parallel waveguide 106B, the phase difference between light passing through the parallel waveguide 106A and light passing through the parallel waveguide 106B can be adjusted. Hereinbelow, phase shifters to constantly introduce a phase difference of π/2 between light passing through the parallel waveguide 106A and light passing through the parallel waveguide 106B like the delay line 108 or the heater are called DC phase shifters (DC phase shifters).

The phase shifters 107 are RF phase shifters (high-frequency phase shifters) driven by a high-frequency signal. For example, the phase shifters 107 perform high-speed modulation when a high-frequency electric signal in the tens of GHz bandwidth is input to the phase shifters 107. In addition, the phase shifters 107 are diodes formed by providing p-i-n junctions or p-n junctions to the silicon substrate of the optical modulator 100. Light passing through the phase shifters 107 (diodes) formed on the silicon substrate can be phase-shifted since the refractive indices of the phase shifters 107 change depending on a voltage or a current flowing through the phase shifters 107. The optical modulator 100 makes adjustments so that the ON state and the OFF state of an electric signal input to the phase shifters 107 correspond to the ON state and the OFF state of light.

Important characteristics of the optical modulator 100 include high frequency characteristics, optical loss characteristics, and the dynamic extinction ratio (or light modulation amplitude). The high frequency characteristics are characteristics that are important for speeding up the switching of the ON state and the OFF state of an electric signal that drives the optical modulator 100, and it is necessary to reduce bandwidth degradation as much as possible. The optical loss characteristics are primarily caused by the absorption losses of materials included in the phase shifters, and need to be minimized as much as possible.

In addition, the dynamic extinction ratio is the power ratio between the optical power in the optical modulation ON state and the optical power in the optical modulation OFF state, and it is important to increase the dynamic extinction ratio as much as possible. Note that, by enhancing the dynamic extinction ratio, the light modulation amplitude, which is the power difference between the optical power in the optical modulation ON state and the optical power in the optical modulation OFF state is also enhanced.

The optical modulator 100 is an MZ type silicon optical modulator generated using silicon photonics. Since the MZ type silicon optical modulator uses the carrier plasma effect for the phase shifters 107, optical losses caused by the carrier plasma effect increase as the lengths of the phase shifters 107 increase. Because of this, the length of a traveling-wave electrode for applying an electric signal to the optical modulator needs also to be increased depending on the lengths of the phase shifters 107, and high-frequency losses in the traveling-wave electrode cause bandwidth degradation in the high frequency characteristics.

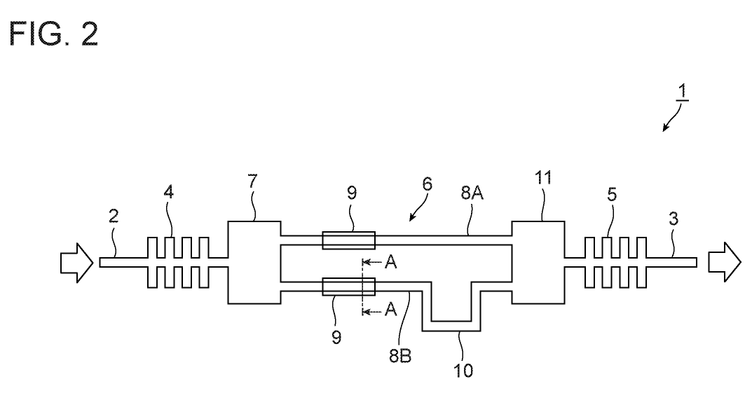

In contrast to this, in an optical modulator according to the first embodiment, semi-transparent-type mirrors (hereinbelow, written as semi-transparent mirrors) are arranged on the light-entrance-side waveguide and the light-output-side waveguide of an MZ type silicon optical modulator. Thereby, the dynamic extinction ratio can be enhanced without causing optical losses or bandwidth degradation in the high frequency characteristics. Along with this, the light modulation amplitude can also be enhanced. Hereinbelow, the optical modulator according to the first embodiment is explained using FIG. 2.

FIG. 2 is a planar schematic diagram schematically illustrating the configuration of an optical modulator 1 according to the first embodiment. In FIG. 2, similarly to the optical modulator 100, the optical modulator 1 is an MZ type optical modulator, and includes a light-entrance-side waveguide 2, a light-output-side waveguide 3, a grating 4, a grating 5, and an optical resonator 6. The optical resonator 6 is an optical resonator having an MMI 7, parallel waveguides 8A and 8B, phase shifters 9, a delay line 10, and an MMI 11.

The light-entrance-side waveguide 2 and the light-output-side waveguide 3 are optical waveguides formed on a silicon substrate. The light-entrance-side waveguide 2 is an optical waveguide where light enters as represented by an arrow in FIG. 2. The light-output-side waveguide 3 is an optical waveguide where light having passed through the grating 4, the optical resonator 6, and the grating 5 is output as represented by an arrow in FIG. 2.

The grating 4 is provided on the light-entrance-side waveguide 2, and is a first semi-transparent mirror for changing the refractive index of light in the light-entrance-side waveguide 2. For example, the grating 4 is configured to change a waveguide width so that the effective refractive index changes periodically in the propagation direction of light with respect to the light-entrance-side waveguide 2.

The grating 5 is provided on the light-output-side waveguide 3, and is a second semi-transparent mirror for changing the refractive index of light in the light-output-side waveguide 3. Similarly to the grating 4, the grating 5 is configured to change a waveguide width so that the effective refractive index changes periodically with respect to the propagation direction of light in the light-output-side waveguide 3.

The MMI 7 is a branching unit to branch light having passed through the grating 4 to the parallel waveguide 8A and the parallel waveguide 8B. Note that the branching unit may be a Y-branch waveguide. The MMI 11 is a multiplexing unit to multiplex light having passed through the parallel waveguide 8A and light having passed through the parallel waveguide 8B, and outputs the multiplexed light to the grating 5. Note that the multiplexing unit may be a Y-branch waveguide. The parallel waveguide 8A is an optical waveguide that is formed in parallel with the parallel waveguide 8B on the silicon substrate of the optical modulator 1. The parallel waveguide 8B is an optical waveguide that is formed in parallel with the parallel waveguide 8A on the silicon substrate of the optical modulator 1.

The phase shifters 9 are phase shifters to phase-shift light passing through the parallel waveguide 8A and light passing through the parallel waveguide 8B. The phase shifters 9 are RF phase shifters driven by a high-frequency signal.

For example, the phase shifters 9 are diodes including p-i-n junctions (carrier injection type) or p-n junctions (carrier depletion type) that are formed on the silicon substrate of the optical modulator 1. Light passing through the phase shifters 9 formed on the silicon substrate can be phase-shifted by changing the refractive indices of the phase shifters 9 depending on a voltage or a current flowing through the phase shifters 9. The optical modulator 1 makes adjustments so that the ON state and the OFF state of an electric signal input to the phase shifters 9 correspond to the ON state and the OFF state of light.

The delay line 10 is a phase shifter to phase-shift light passing through the parallel waveguide 8B. Light having been propagated through the parallel waveguide 8B from the light entrance-side to the light output side experiences a phase delay by being propagated through the delay line 10. The delay line 10 has a significant wavelength dependency in the phase shift amount of light passing through the parallel waveguide 8B. In other words, by changing the incident wavelength of light passing through the parallel waveguide 8B, the phase difference between light passing through the parallel waveguide 8A and light passing through the parallel waveguide 8B can be adjusted. The delay line 10 is a DC phase shifter to constantly introduce a phase difference of π/2 between light passing through the parallel waveguide 8A and light passing through the parallel waveguide 8B.

Note that, although not illustrated in FIG. 2, instead of the delay line 10, a heater is installed in some cases. For example, in a case where a heater is installed on the parallel waveguide 8B, the heater heats the core of the parallel waveguide 8B. Due to the thermo-optic effect, the refractive index of light of the parallel waveguide 8B changes, and the light passing through the parallel waveguide 8B is phase-shifted.

Next, an operation performed by the optical modulator 1 is explained. The optical modulator 1 includes the optical resonator 6 provided between the grating 4 and the grating 5. In the optical modulation ON state (symbol "1"), the optical resonator 6 outputs, to the grating 5, multiplexed light of light having passed through the parallel waveguide 8A and light having passed through the parallel waveguide 8B without introducing a phase difference therebetween. That is, in the optical modulator 1, refractive indices of the phase shifters 9 that are determined such that light having passed through the parallel waveguide 8A and light having passed through the parallel waveguide 8B interfere with each other, with their phase difference of almost zero. At this time, the wavelength that resonates in the optical resonator 6 at this time is the operating wavelength.

In the ON state of optical modulation, the optical resonator 6 satisfies the resonance wavelength condition. Because of this, resonant tunneling occurs inside the optical resonator 6, and light is transmitted from the light-entrance-side waveguide 2 to the light-output-side waveguide 3 without any loss. In the optical modulation ON state, the optical resonator 6 has transmittance which is equivalent to that of the optical modulator 100 not including the grating 4 and the grating 5, and light arrives at the light-output-side waveguide 3 at the transmittance.

In the optical modulation OFF state (symbol "0"), the optical resonator 6 outputs, to the grating 5, multiplexed light of light having passed through the parallel waveguide 8A and light having passed through the parallel waveguide 8B with a phase difference being introduced therebetween.

That is, the optical modulator 1 has refractive indices of the phase shifters 9 that is determined so that light having passed through the parallel waveguide 8A and light having passed through the parallel waveguide 8B interfere with each other, in a state where the phase difference between the light is almost π. At this time, an anti-resonant state occurs at the operating wavelength of the optical resonator 6.

This is because the refractive indices of the parallel waveguides 8A and 8B change, and the resonance wavelength condition of the optical resonator 6 changes.

In the OFF state of optical modulation, the optical resonator 6 transitions to an anti-resonance wavelength condition. Because of this, anti-resonant reflection occurs inside the optical resonator 6, and the transmittance of light from the light-entrance-side waveguide 2 to the light-output-side waveguide 3 lowers. That is, in the optical modulation OFF state, in the optical resonator 6, the transmittance lowers further by a degree corresponding to the anti-resonant reflection compared to the transmittance of the optical modulator 100 not including the grating 4 and the grating 5. In this manner, the power ratio and power difference of light that passes from the light-entrance-side waveguide 2 to the light-output-side waveguide 3 can be obtained between the optical modulation ON state and the optical modulation OFF state. Thereby, the optical modulator 1 can enhance the dynamic extinction ratio, and enhance the light modulation amplitude without causing optical losses or bandwidth degradation in the high frequency characteristics.

Since a high dynamic extinction ratio and a high light modulation amplitude can be obtained in the optical modulator 1 without increasing the lengths of the phase shifters for the purpose of obtaining a significant refractive index change, the increase in optical loss is reduced, and the bandwidth degradation in the high frequency characteristics also is reduced. Moreover, in the optical modulator 1, the dynamic extinction ratio and the light modulation amplitude can be enhanced without providing a structure to lower the group velocity of light to the phase shifters 9. Thereby, the optical modulator 1 can reduce optical loss, and furthermore can reduce degradation of a light modulation waveform due to inter-symbol interference caused by mismatches between the group velocity of light and the phase velocity of high-frequency signals. Note that, for example, light having returned to the light-entrance-side waveguide 2 due to anti-resonant reflection from the optical modulator 1 in the OFF state of optical modulation is attenuated by an optical isolator included in a laser light source (hereinbelow, written as an external laser light source) provided outside the optical modulator 1. Thereby, in the optical modulator 1, noise caused by backlight to a laser element included in the external laser light source decreases.

Next, the advantageous effects achieved by the optical modulator 1 are explained quantitatively. First, the structure of the phase shifters 9 included in the optical modulator 1 is explained.

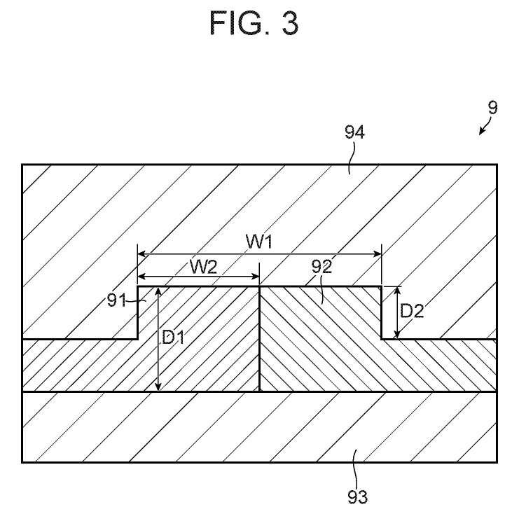

FIG. 3 is an enlarged cross-sectional view illustrating a cross section of the optical modulator 1 taken along line A-A in FIG. 2, and illustrates a cross section of a phase shifter 9. In FIG. 3, the phase shifter 9 is a carrier-depletion-type RF phase shifter having a p-n junction. The rib waveguide width W1 is 400 nm, half of the width, the width W2, is 200 nm, and the position corresponding to the width W2 is the rib center. It is assumed that, at the rib center, there is the p-n junction interface between a p-type semiconductor 91 and an n-type semiconductor 92.

The p-type semiconductor 91 and the n-type semiconductor 92 are formed on a silicon oxide film (SiO₂) 93 of the silicon-on-insulator substrate of the optical modulator 1. A silicon oxide layer 94 is stacked on the rib including the p-type semiconductor 91 and the n-type semiconductor 92. In addition, it is assumed that the silicon film thickness D1 is 200 nm, and the half etching depth D2 for forming a rib-type waveguide is 110 nm.

It is assumed that, in the phase shifter 9, the impurity densities of the p-type semiconductor 91 and the n-type semiconductor 92 are 1×10¹⁸cm⁻³. In addition, it is assumed that the length of the phase shifter 9 is 2 mm.

Furthermore, it is assumed that, in the optical modulator 1, the delay line 10 illustrated in FIG. 2 has such a length that the free spectral interval corresponds to 11 nm in relation to the wavelength.

Furthermore, it is assumed that the driving condition of the optical modulator 1 includes the offset reverse bias of 2 V, and the driving voltage amplitude of 1.6 V.

It is assumed that the optical modulator 1 has a structure in which the optical resonator 6 is sandwiched by the grating 4 and the grating 5 having transmittance characteristics and reflectance characteristics that cause a ripple of 0.02% in the transmittance of the optical spectrum.

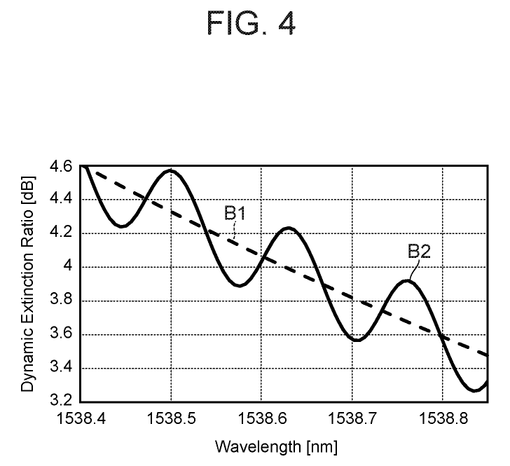

FIG. 4 is a graph illustrating the wavelength dependency of the dynamic extinction ratios of the optical modulator 1 and the optical modulator 100. In FIG. 4, the horizontal axis represents the wavelength (nm) of incident light, and the vertical axis represents the dynamic extinction ratios (dB) of the optical modulator 1 and the optical modulator 100. Characteristics B1 represented by a broken line are characteristics representing the wavelength dependency of the dynamic extinction ratio of the conventional optical modulator 100 illustrated in FIG. 1. In addition, characteristics

B2 represented by a solid line are characteristics representing the wavelength dependency of the dynamic extinction ratio of the optical modulator 1.

As is apparent from the characteristics B1, in the optical modulator 100, the increase in the dynamic extinction ratio with the decrease in the wavelength of light is caused by the deviation of the phase difference between light passing through the parallel waveguide 106A and light passing through the parallel waveguide 106B from the optimum π/2, which is caused by the delay line 108. Stated differently, this is because the cross point of a light modulation waveform becomes smaller than the optimum 50%, and actually 1538.63 nm, which is a wavelength where the cross point matches 50%, is the operating wavelength.

In addition, as is apparent from the characteristics B2, the dynamic extinction ratio of the optical modulator 1 also increases as the wavelength of light decreases. This is because the cross point becomes smaller than the optimum 50%.

On the other hand, since there is a wavelength where the dynamic extinction ratio increases periodically in relation to the wavelength in the optical modulator 1, for example, if 1538.63 nm is the operating wavelength, a high dynamic extinction ratio and a high light modulation amplitude can be obtained. If the reflectance of the grating 4 and the grating 5, which are semi-transparent mirrors, are higher, and a ripple to be caused in the transmittance of the optical spectrum of the optical resonator 6 is more significant, the increase amount of the dynamic extinction ratio that periodically appears as illustrated in FIG. 4 increases further, and more significant advantageous effects can be achieved.

In addition, there is a modification example of the optical modulator 1 as described below.

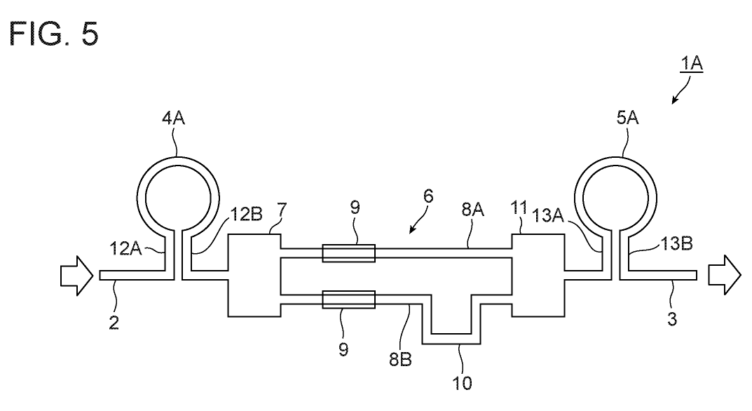

FIG. 5 is a planar schematic diagram schematically illustrating the configuration of an optical modulator 1A which is a modification example of the optical modulator 1. In FIG. 5, the optical modulator 1A includes a loop mirror 4A and a loop mirror 5A instead of the grating 4 and the grating 5 in the optical modulator 1.

The loop mirror 4A is a first semi-transparent mirror provided on a light-entrance-side waveguide 2. The loop mirror 5A is a second semi-transparent mirror provided on a light-output-side waveguide 3.

The loop mirror 4A is configured to function as a semi-transparent mirror by coupling part of optical power to an adjacent waveguide in an area where a loop-connected waveguide 12A and a loop-connected waveguide 12B are in close proximity. Similarly, the loop mirror 5A is configured to function as a semi-transparent mirror by coupling part of optical power to an adjacent waveguide in an area where a loop-connected waveguide 13A and a loop-connected waveguide 13B are in close proximity. By using the loop mirror 4A and the loop mirror 5A as semi-transparent mirrors, the optical modulator 1A can achieve advantageous effects equivalent to those of the optical modulator 1.

As mentioned above, the optical modulator 1 according to the first embodiment includes: the light-entrance-side waveguide 2, the light-output-side waveguide 3, the grating 4 provided on the light-entrance-side waveguide 2, the grating 5 provided on the light-output-side waveguide 3, and the optical resonator 6. The optical resonator 6 has: the MMI 7 that is provided between the grating 4 and the grating 5, and branches light having passed through the grating 4; the parallel waveguides 8A and 8B extending in parallel from the MMI 7; and the MMI 11 to multiplex light having passed through the parallel waveguide 8A and light having passed through the parallel waveguide 8B, and output the multiplexed light to the grating 5. Then, the optical resonator 6 outputs, to the grating 5, multiplexed light of the light having passed through the parallel waveguide 8A and the light having passed through the parallel waveguide 8B without introducing a phase difference therebetween in the optical modulation ON state, and outputs, to the grating 5, multiplexed light of the light having passed through the parallel waveguide 8A and the light having passed through the parallel waveguide 8B with a phase difference introduced therebetween in the optical modulation OFF state.

The refractive indices of light of the parallel waveguides 8A and 8B are determined such that the light having passed through the parallel waveguide 8A and the light having passed through the parallel waveguide 8B interfere with each other with a phase difference of almost 0 in the optical modulation ON state. If the operating wavelength is a wavelength that satisfies a resonance condition that is determined by the refractive indices and the length between the grating 4 (or the loop mirror 4A) and the grating 5 (or the loop mirror 5A), the light having passed through the parallel waveguide 8A and the light having passed through the parallel waveguide 8B undergo resonant tunneling at the optical resonator 6, and the light passes from the light-entrance-side waveguide 2 to the light-output-side waveguide 3 without any loss.

On the other hand, since the refractive indices of light of the parallel waveguides 8A and 8B are determined such that a phase difference is introduced between the light having passed through the parallel waveguide 8A and the light having passed through the parallel waveguide 8B in the optical modulation OFF state, the power of light that passes from the light-entrance-side waveguide 2 to the light-output-side waveguide 3 lowers depending on the phase difference. Moreover, with the refractive indices, the resonance condition is no longer satisfied between the grating 4 (or the loop mirror 4A) and the grating 5 (or the loop mirror 5A). Accordingly, light having entered from the light-entrance-side waveguide 2 undergoes anti-resonant reflection, thereby further lowering the power of light that passes to the light-output- side waveguide 3.

Thereby, the power ratio and power difference of light that passes from the light-entrance-side waveguide 2 to the light-output-side waveguide 3 can be obtained between the optical modulation ON state and the optical modulation OFF state. Accordingly, the optical modulator 1 can enhance the dynamic extinction ratio without causing optical losses or bandwidth degradation in the high frequency characteristics.

In the optical modulators 1 and 1A according to the first embodiment, the first semi-transparent mirror and the second semi-transparent mirror are the gratings 4 and 5 or the loop mirrors 4A and 5A. Thereby, in the optical modulators 1 and 1A, the power ratio and power difference of light that passes from the light-entrance-side waveguide 2 to the light-output-side waveguide 3 can be obtained between the optical modulation ON state and the optical modulation OFF state.

In the optical modulator 1 according to the first embodiment, the optical resonator 6 includes the phase shifters to phase-shift light passing through the parallel waveguide 8A and light passing through the parallel waveguide 8B. Thereby, in the optical modulators 1 and 1A, the power ratio and power difference of light that passes from the light-entrance-side waveguide 2 to the light-output-side waveguide 3 can be obtained between the optical modulation ON state and the optical modulation OFF state.

In the optical modulator 1 according to the first embodiment, the phase shifters 9 include waveguides of p-i-n junctions or p-n junctions. Thereby, in the optical modulators 1 and 1A, the power ratio and power difference of light that passes from the light-entrance-side waveguide 2 to the light-output-side waveguide 3 can be obtained between the optical modulation ON state and the optical modulation OFF state.

In the optical modulator 1 according to the first embodiment, the phase shifters include the delay line 10 or a heater provided on the parallel waveguide 8B. Thereby,

in the optical modulators 1 and 1A, the power ratio and power difference of light that passes from the light-entrance-side waveguide 2 to the light-output-side waveguide 3 can be obtained between the optical modulation ON state and the optical modulation OFF state.

Note that modifications of any constituent elements of the embodiment and omissions of any constituent elements of the embodiment are possible.

### INDUSTRIAL APPLICABILITY

For example, the optical modulators according to the present disclosure can be used for optical communication of a data center.

### REFERENCE SIGNS LIST

1, 1A: Optical modulator; 2: Light-entrance-side waveguide; 3: Light-output-side waveguide; 4, 5: Grating; 4A, 5A: Loop mirror; 6: Optical resonator; 7, 11: MMI; 8A, 8B: Parallel waveguide; 9: Phase shifter; 10: Delay line; 100: Optical modulator; 101: Light-entrance-side waveguide; 102: Light-output-side waveguide; 103: MZ interferometer; 104, 105: MMI; 106A, 106B: Parallel waveguide; 107: Phase shifter; 108: Delay line

1. An optical modulator comprising:
a light-entrance-side waveguide where light enters;
a light-output-side waveguide where light is output;
a first semi-transparent mirror provided on the light-entrance-side waveguide;
a second semi-transparent mirror provided on the light-output-side waveguide; and
an optical resonator provided between the first semi-transparent mirror and the second semi-transparent mirror, and having: a branch to branch light having passed through the first semi-transparent mirror; parallel waveguides that extend in parallel from the branch, and allow passage of light branched by the branch; and a multiplexer to multiplex light having passed through the parallel waveguides, and output the multiplexed light to the second semi-transparent mirror, wherein
the optical resonator
outputs, to the second semi-transparent mirror, the multiplexed light of the light having passed through the parallel waveguides without introducing a phase difference therebetween in an optical modulation ON state, and
outputs, to the second semi-transparent mirror, the multiplexed light of the light having passed through the parallel waveguides with a phase difference introduced therebetween in an optical modulation OFF state.

2. The optical modulator according to claim 1, wherein the first semi-transparent mirror and the second semi-transparent mirror are gratings or loop mirrors.

3. The optical modulator according to claim 1, wherein the optical resonator includes a phase shifter to phase-shift the light passing through the parallel waveguides.

4. The optical modulator according to claim 3, wherein the phase shifter includes a waveguide with a p-i-n junction or a p-n junction.

5. The optical modulator according to claim 3, wherein the phase shifter includes a delay line or a heater provided on the parallel waveguides.

6. The optical modulator according to claim 1, wherein the branch and the multiplexer are multimode interference waveguides or Y-branch waveguides.
